(19) United States
(12) Patent Application Publication
(10) Pub. No.: US 2025/0167478 A1
(43) Pub. Date: May 22, 2025

(54) CONNECTOR

(71) Applicant: SUMITOMO WIRING SYSTEMS, LTD., Mie (JP)

(72) Inventor: Daisuke KATAOKA, Mie (JP)

(21) Appl. No.: 18/938,839

(22) Filed: Nov. 6, 2024

(30) Foreign Application Priority Data
Nov. 16, 2023 (JP) 2023-195379

(51) Int. Cl. H01R 13/424; H01R 13/52; H01R 13/64

(52) U.S. Cl. CPC H01R 13/424; H01R 13/521; H01R 13/64

(57) ABSTRACT

A connector 10, 10A includes a housing 20, 20A and a detecting member 60, 60A movable from an initial position to a detection position forward of the initial position when a mating connector 100 and the housing 20, 20A are properly connected. The housing 20, 20A includes a cavity 24 extending in a front-rear direction for accommodating a terminal fitting 40 and a rear end tube portion 26, 26A surrounding a rear part of the cavity, a wire W connected to the terminal fitting 40 being pulled out from the rear end tube portion 26, 26A. The detecting member 60, 60A includes a fitting portion 62, 62A to be fit to an outer peripheral surface of the rear end tube portion 26, 26A at the detection position.

### CROSS-REFERENCE TO RELATED APPLICATIONS

This application is based on and claims priority from Japanese Patent Application No. 2023-195379, filed on Nov. 16, 2023, with the Japan Patent Office, the disclosure of which is incorporated herein in its entirety by reference.

### TECHNICAL FIELD

The present disclosure relates to a connector.

### BACKGROUND

A connector disclosed in Japanese Patent Laid-open Publication No. 2021-068498 is provided with a connector housing and a connection detecting member (hereinafter, referred to as a detecting member) to be mounted into the connector housing movably in a front-rear direction between a temporary locking position and a complete locking position. The connector housing is formed with a detecting member mounting portion for movably accommodating the detecting member. The detecting member becomes movable from the temporary locking position to the complete locking position when the connector housing and a mating housing are properly connected. When the detecting member becomes movable to the complete locking position, it can be judged (detected) that the connector housing and the mating housing have been properly connected. Note that a member to be mounted into the connector housing is not limited to the detecting member and, for example, a rear holder for preventing a rubber plug from coming out from the connector housing is also known as such (see Japanese Patent Laid-open Publication Nos. 2003-077583 and 2010-108765).

### SUMMARY

In the case of Japanese Patent Laid-open Publication No. 2021-068498, there has been a concern that the detecting member at a detection position rattles with respect to the detecting member mounting portion.

Accordingly, the present disclosure aims to provide a connector capable of suppressing the rattling of a detecting member with respect to a housing.

The present disclosure is directed to a connector with a housing connectable to a mating connector and a detecting member to be mounted into the housing movably in a front-rear direction, the detecting member being movable from an initial position to a detection position forward of the initial position when the mating connector and the housing are properly connected, the housing including a cavity extending in the front-rear direction for accommodating a terminal fitting and a rear end tube portion surrounding a rear part of the cavity, a wire connected to the terminal fitting being pulled out from the rear end tube portion, and the detecting member including a fitting portion to be fit to an outer peripheral surface of the rear end tube portion at least at the detection position.

According to the present disclosure, it is possible to provide a connector capable of suppressing the rattling of a detecting member with respect to a housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side view in section showing a state where a housing is properly connected to a mating connector and a detecting member is at a detection position with respect to the housing in a connector of a first embodiment.

FIG. 2 is a back view of the connector of the first embodiment in the state of FIG. 1.

FIG. 3 is a side view in section showing a state where a terminal fitting is accommodated in a cavity of the housing when the detecting member is at an initial position with respect to the housing in the connector of the first embodiment.

FIG. 4 is a plan view in section showing a state where locked surfaces are locked to locking portions and the detecting member is restricted from coming out rearward when the detecting member is at the initial position with respect to the housing in the connector of the first embodiment.

FIG. 5 is a perspective view of the housing when viewed from behind in the connector of the first embodiment.

FIG. 6 is a perspective view of the detecting member when viewed obliquely from a front upper side in the connector of the first embodiment.

FIG. 7 is a perspective view of the detecting member when viewed obliquely from a front lower side in the connector of the first embodiment.

FIG. 8 is a front view of the detecting member in the connector of the first embodiment.

FIG. 9 is a side view in section showing a state where a detecting member is at a detection position with respect to a housing in a connector of a second embodiment without showing a mating connector.

FIG. 10 is a perspective view of a sealing member in the connector of the second embodiment.

FIG. 11 is a back view of the housing in the connector of the second embodiment.

FIG. 12 is a perspective view of a detecting member when viewed obliquely from a rear upper side in the connector of the second embodiment.

FIG. 13 is a front view of the detecting member in the connector of the second embodiment.

FIG. 14 is a side view in section showing a state where the sealing member is held in a holding space of a fitting portion and the detecting member is at an initial position with respect to the housing in the connector of the second embodiment.

FIG. 15 is a side view in section showing a state where a terminal fitting is accommodated into a cavity of the housing from the state of FIG. 14, the housing is properly connected to the mating connector, and the detecting member is at a detection position with respect to the housing in the connector of the second embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

Embodiments of the present disclosure are first listed and described.
(1) The connector of the present disclosure is provided with a housing connectable to a mating connector and a detecting member to be mounted into the housing movably in a front-rear direction, the detecting member being movable from an initial position to a detection position forward of the initial position when the mating connector and the housing are properly connected, the housing including a cavity extending in the front-rear direction for accommodating a terminal fitting and a rear end tube portion surrounding a rear part of the cavity, a wire connected to the terminal fitting being pulled out from the rear end tube portion, and the detecting member including a fitting portion to be fit to an outer peripheral surface of the rear end tube portion at least at the detection position.

According to the configuration of (1) described above, rattling between the housing and the detecting member can be suppressed by fitting the fitting portion to the outer peripheral surface of the rear end tube portion at the detection position.
(2) Preferably, in the connector of (1) described above, the fitting portion is lightly fit to the outer peripheral surface of the rear end tube portion at the initial position and more deeply fit to the outer peripheral surface of the rear end tube portion at the detection position.

According to the configuration of (2) described above, since the fitting portion is fit to the rear end tube portion not only at the detection position, but also at the initial position, the rattling of the detecting member with respect to the housing can be suppressed also at the initial position.
(3) In the connector of (1) or (2) described above, a detection lock portion to be locked to the housing at each of the initial position and the detection position may be arranged at a position in front of and above the fitting portion in the detecting member.

According to the configuration of (3) described above, since the detection lock portion of the detecting member can be hindered from being inclined downward or upward toward the front inside the housing by the fitting portion, a state where the detection lock portion is locked to the housing can be more stably maintained.
(4) In the connector of any one of (1) to (3) described above, a step-like anti-slip portion may be formed on an outer peripheral surface of the fitting portion.

According to the configuration of (4) described above, since a worker can move the detecting member by gripping the anti-slip portion, workability is excellent. Particularly, in the configuration of (4) described above, the anti-slip portion can be efficiently formed in a wide range of the outer peripheral surface of the fitting portion.
(5) Preferably, in the connector of any one of (1) to (4) described above, a sealing member is further provided which includes a sealing hole, the wire being liquid-tightly insertable through the sealing hole, the fitting portion includes a holding portion for holding the sealing member and an opening for opening the sealing hole of the sealing member rearward, and the opening communicates with the cavity and an outer peripheral surface of the sealing member is held in close contact with an inner peripheral surface of the rear end tube portion when the detecting member reaches the detection position with respect to the housing.

When the detecting member is at the initial position, the terminal fitting is inserted into the cavity of the housing through the opening. If the position of the terminal fitting passing through the inside of the opening is not determined at the initial position, the terminal fitting may be shifted from a position where the terminal fitting is insertable into the cavity. In that respect, according to the configuration of (5) described above, when the detecting member is at the initial position, the sealing member is held in the fitting portion and the terminal fitting can be passed through the sealing hole of this sealing member. Thus, the position of the terminal fitting passing through the inside of the opening is determined to be the position where the terminal fitting is insertable into the cavity. As a result, an operation of inserting the terminal fitting into the cavity can be smoothly performed.
(6) Preferably, in the connector of (5) described above, the housing is formed with a plurality of the cavities, the plurality of cavities collectively communicate with the opening, and the sealing member is a one-piece rubber plug including a plurality of the sealing holes capable of communicating with the plurality of cavities.

If the plurality of cavities collectively communicate with one opening, an opening diameter of the opening increases and it becomes difficult to determine the position of the terminal fitting passing through the inside of the opening. In that respect, according to the configuration of (6) described above, the position of the terminal fitting can be determined without any trouble by each sealing hole since the sealing member is a one-piece rubber plug.

### DETAILS OF EMBODIMENTS OF PRESENT DISCLOSURE

Specific examples of the present disclosure are described below with reference to the drawings. Note that the present invention is not limited to this illustration, but is represented by claims and intended to include all changes in the scope of claims and in the meaning and scope of equivalents.

### First Embodiment

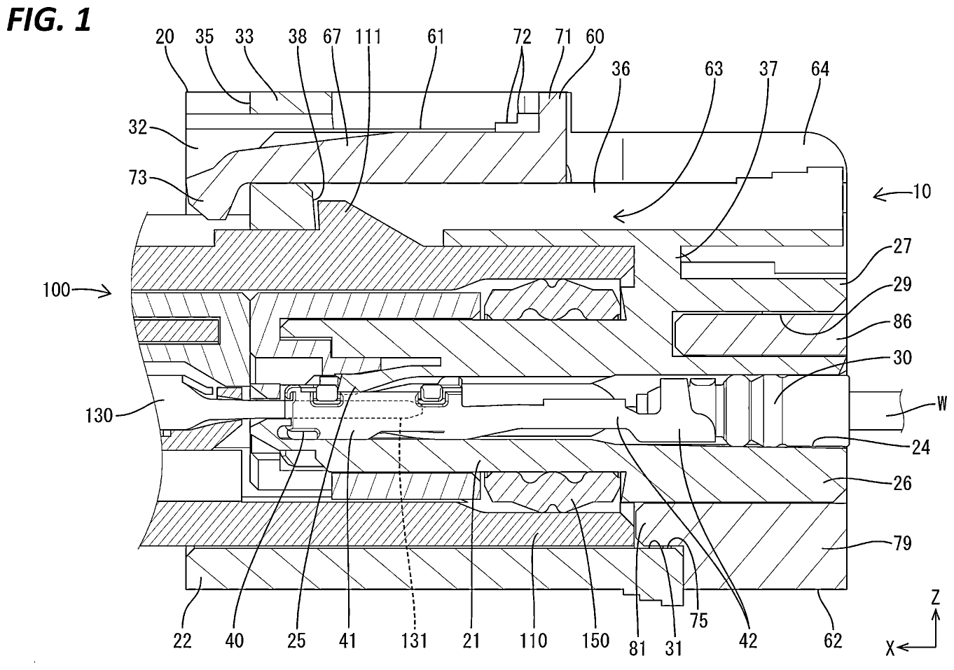

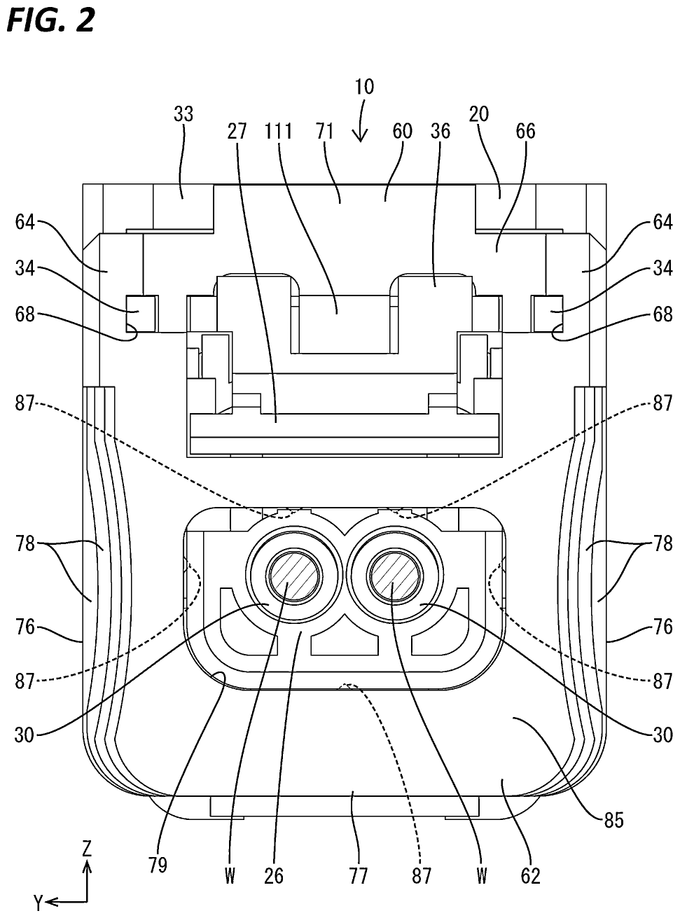

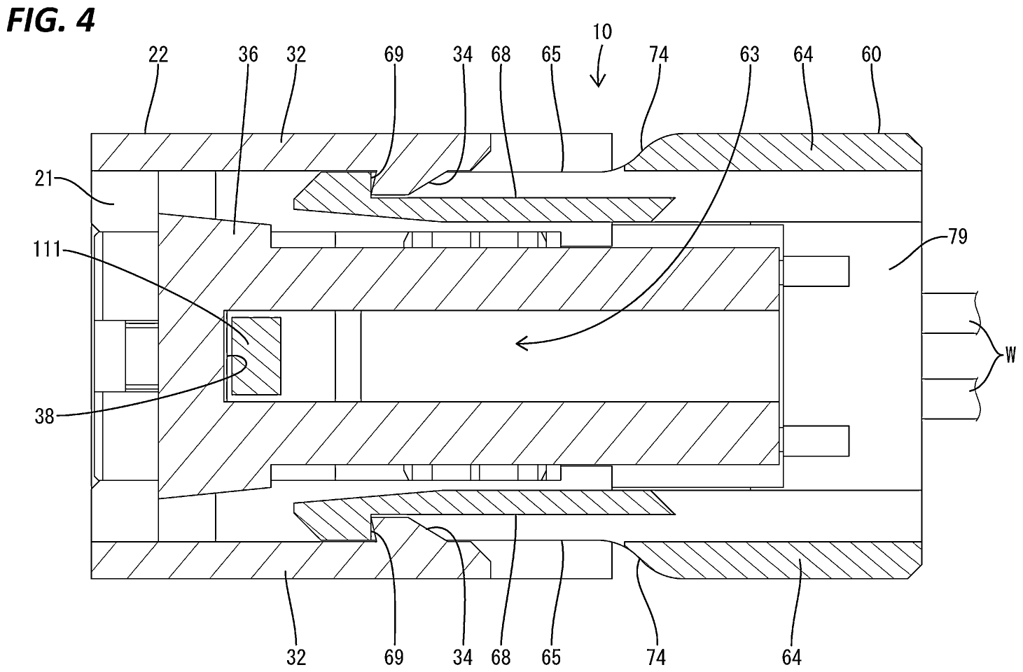

As shown in FIG. 1, a connector 10 of a first embodiment is provided with a housing 20 and a detecting member 60 to be inserted into the housing 20 movably between an initial position and a detection position. The housing 20 is connectable to a mating connector 100. Terminal fittings 40 are accommodated in the housing 20. Note that, in the following description, a moving direction of the detecting member 60 from the initial position to the detection position with respect to the housing 20 is referred to as a forward direction concerning a front-rear direction. A vertical direction is based on a vertical direction of FIGS. 1 to 8 except FIG. 4. A lateral direction is based on a lateral direction of FIGS. 2, 5 and 8. The front-rear direction is indicated by an arrow X and the vertical direction is indicated by an arrow Z in FIG. 1, and the lateral direction is indicated by an arrow Y in FIG. 2. These direction references are for convenience and do not necessarily coincide with direction references in a state where the connector 10 is installed in an unillustrated vehicle or the like.

### (Housing 20 and Terminal Fittings 40)

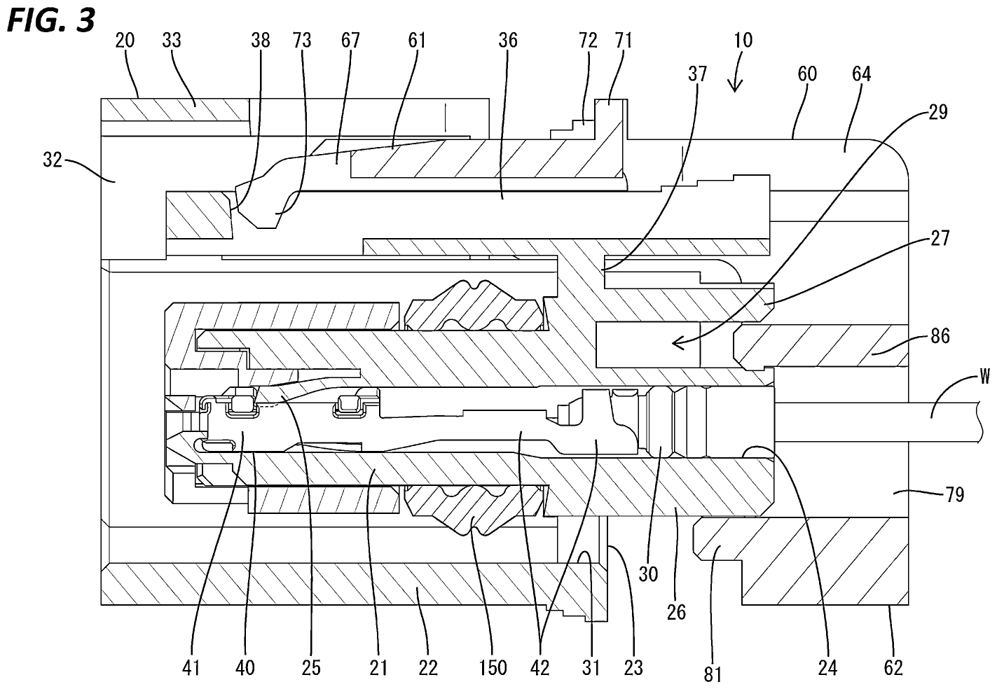

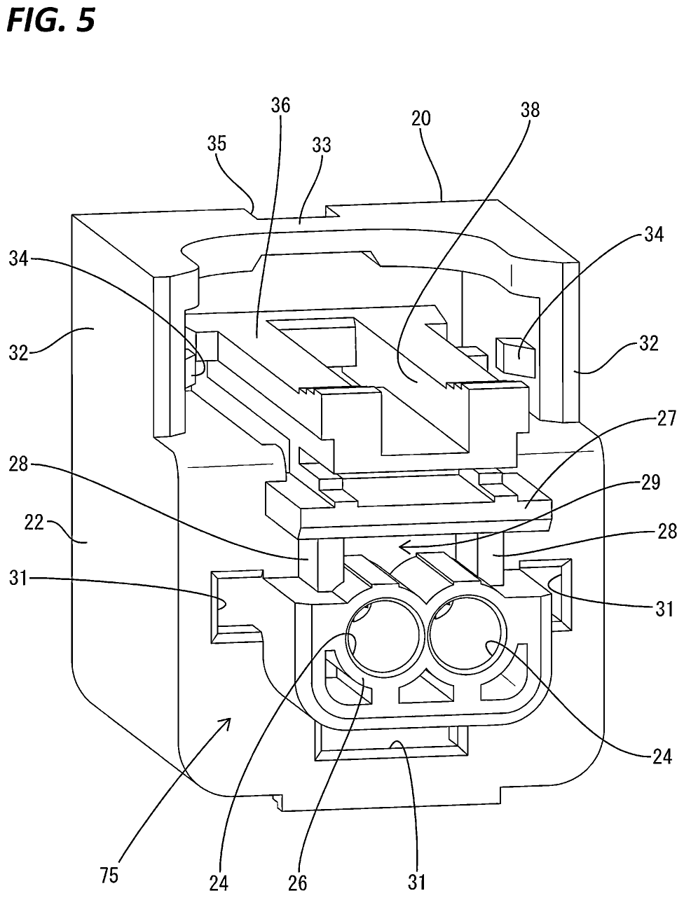

The housing 20 is made of synthetic resin and includes, as shown in FIG. 3, a housing body 21, a fitting tube portion 22 surrounding the housing body 21 and a coupling portion 23 coupling the housing body 21 and the fitting tube portion 22. A receptacle 110 of the mating connector 100 is fit into a space between the fitting tube portion 22 and the housing body 21 and in front of the coupling portion 23 (see FIG. 1). A sealing ring 150 for sealing between the receptacle 110 and the housing 20 is mounted on the outer peripheral surface of the housing body 21. The housing body 21 is formed with cavities 24 extending in the front-rear direction. In the case of the first embodiment, two cavities 24 are arranged side by side in the lateral direction as shown in FIG. 5. A resiliently deformable locking lance 25 is formed to project on the upper surface of the inner wall of each cavity 24. The terminal fitting 40 is inserted and accommodated into each cavity 24 from behind.

The terminal fitting 40 is made of electrically conductive metal and has a shape elongated in the front-rear direction as a whole as shown in FIG. 3. A tubular connecting portion 41 is formed in a front part of the terminal fitting 40. The connecting portion 41 is locked by the locking lance 25 while being accommodated in the cavity 24. As shown in FIG. 1, a tab 131 of a mating terminal fitting 130 is inserted and connected to the connecting portion 41 from front. A barrel portion 42 is formed in a rear part of the terminal fitting 40. The barrel portion 42 is electrically and mechanically connected to an end part of a wire W.

As shown in FIG. 3, the housing body 21 includes a rear end tube portion 26 projecting rearward from the coupling portion 23. A rear part of each cavity 24 is formed to penetrate through the inside of the rear end tube portion 26. A rubber plug 30 mounted on the end part of the wire W is liquid-tightly inserted into the rear part of each cavity 24. The rear parts of the respective cavities 24 have a circular internal shape corresponding to the external shape of the rubber plug 30 and are open side by side in the lateral direction in the rear surface of the rear end tube portion 26 as shown in FIG. 5.

As shown in FIGS. 3 and 5, the housing body 21 includes a facing portion 27 in the form of a horizontal plate projecting rearward from the coupling portion 23. The facing portion 27 is arranged above the rear end tube portion 26 and spaced apart from the rear end tube portion 26. As shown in FIG. 5, the facing portion 27 and the rear end tube portion 26 are coupled to each other via side end portions 28 extending in the vertical direction. A pair of the side end portions 28 are arranged below the facing portion 27. A facing space 29 is formed to be open rearward among the rear end tube portion 26, the facing portion 27 and the respective side end portions 28.

As shown in FIG. 5, a plurality of through portions 31 are formed at intervals around the rear end tube portion 26 in the rear surface of the coupling portion 23. The respective through portions 31 are in the shape of rectangular openings and arranged at positions on both left and right sides across the rear end tube portion 26 and a position below the rear end part 26 on a side opposite to the facing portion 27 in a back view.

As shown in FIG. 5, a pair of side wall portions 32 facing each while being spaced apart in the lateral direction and a bridge portion 33 bridged between the respective side wall portions 32 are formed in an upper part of the fitting tube portion 22. Each side wall portion 32 is shaped to extend long in the front-rear direction and arranged to continuously rise from a lower part of the fitting tube portion 22. The bridge portion 33 is arranged to extend in a width direction between front end parts of the respective side wall portions 32. Locking portions 34 are formed to project on the inner surfaces of the respective side wall portions 32 (surfaces of the respective side wall portions 32 facing each other). As shown in FIG. 4, the respective locking portions 34 are lockable to later-described locked surfaces 69 of the detecting member 60. Further, a lateral central part of the front end of the bridge portion 33 is cut to form a recess 35 as shown in FIG. 1. The recess 35 has a function as a confirmation window used to confirm that the detecting member 60 has reached the detection position.

As shown in FIG. 3, the housing 20 is formed with a lock arm 36. The lock arm 36 is formed to extend both forward and rearward from the upper end of a leg portion 37 rising from the upper surface of the housing body 21. The lock arm 36 is resiliently deformable in the vertical direction with the upper end of the leg portion 37 as a fulcrum. A lock hole 38 is formed to penetrate through the lock arm 36 in the vertical direction. The lock arm 36 is exposed to be visually confirmable in an open space between the respective side wall portions 32 and behind the bridge portion 33.

### (Detecting Member 60)

The detecting member 60 is made of synthetic resin and includes a detection lock portion 61 and a fitting portion 62. As shown in FIG. 1, the detection lock portion 61 is inserted and mounted in an upper space 63 formed around the lock arm 36 in an upper part of the fitting tube portion 22 of the housing 20 at the detection position.

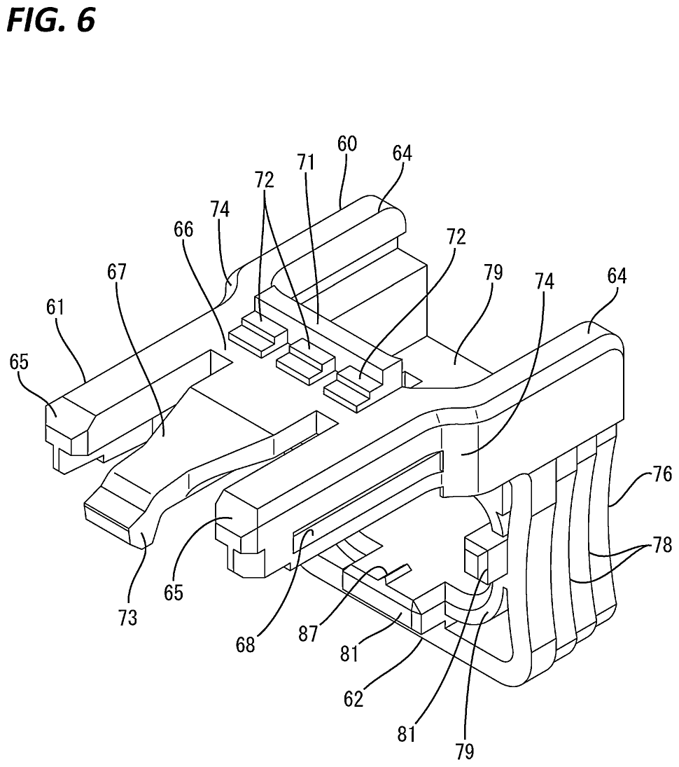

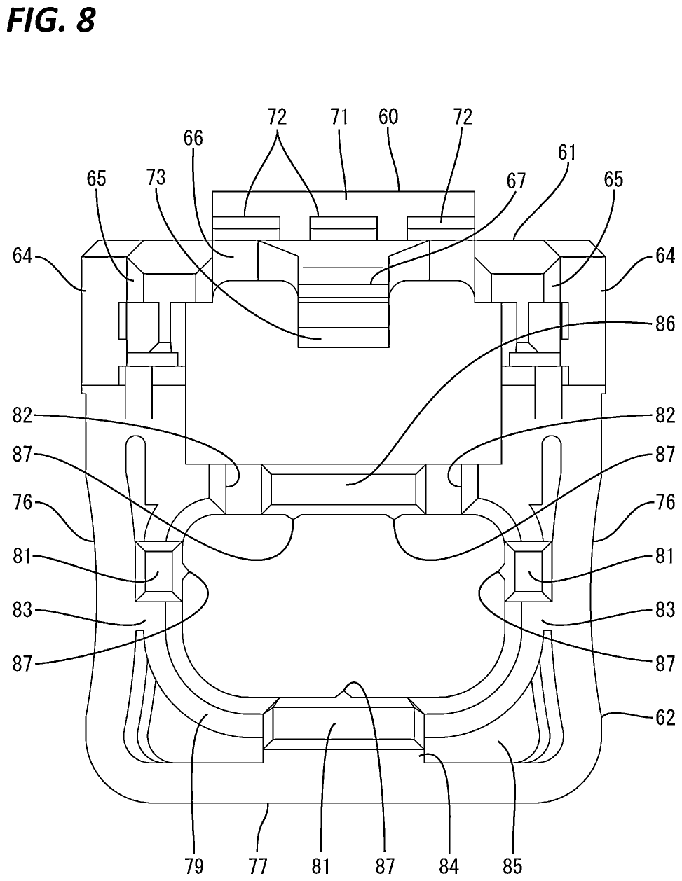

As shown in FIGS. 6 and 8, the detection lock portion 61 includes a pair of base portions 64 facing while being spaced apart in the lateral direction, a pair of projecting portions 65 projecting forward from the respective base portions 64, a linking portion 66 bridged to extend in the width direction between rear end parts of the respective projecting portions 65 and an arm portion 67 projecting forward from a lateral central part of the linking portion 66.

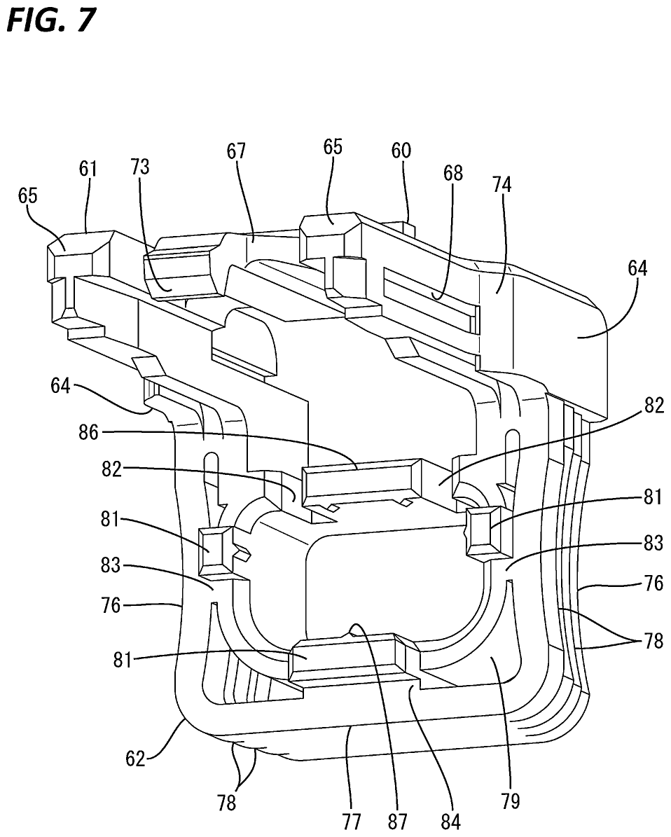

As shown in FIG. 4, the respective projecting portions 65 are arranged to face the inner surfaces of the respective side wall portions 32 in the upper space 63 of the housing 20. As shown in FIGS. 6 and 7, locking recesses 68 are formed in the outer surfaces of the respective projecting portions 65 (surfaces of the respective projecting portions 65 opposite to those facing each other). As shown in FIG. 4, the locking recess 68 is in the form of a groove extending in the front-rear direction, the rear end thereof is open to an inner surface side of the base portion 64 and the front end thereof is closed as the locked surface 69. The locked surface 69 of the locking recess 68 is facing and lockable to the locking portion 34 of the housing 20 from front at the initial position.

As shown in FIG. 6, a projecting wall 71 is formed to project on the upper surface of the linking portion 66. The projecting wall 71 is in the form of a rectangular plate long in the lateral direction. Further, a plurality of step portions 72 rising in a step-like manner toward a rear side are formed on the upper surface of the linking portion 66. The respective step portions 72 are arranged side by side at intervals in the lateral direction. The rear end of each step portion 72 is coupled to the front end of the projecting wall 71. When being moved from the detection position to the initial position, the detecting member 60 can be operated by placing fingers on the projecting wall 71 and the respective step portions 72.

The arm portion 67 is resiliently deformable in the vertical direction with a base end part connected to the linking portion 66 as a fulcrum. A locking projection 73 is formed to project downward on a front end part of the arm portion 67. As shown in FIG. 3, the locking projection 73 is fit into the lock hole 38 of the lock arm 36 and facing and lockable to the front surface (surface located on a front side and facing rearward) of the lock hole 38 at the initial position.

As shown in FIGS. 4 and 6, a front end part of the outer surface of each base portion 64 is formed with a slope portion 74 gradually inclined laterally inward toward the outer surface of each projecting portion 65. The slope portion 74 is arranged to face the rear end surface of the corresponding side wall portion 32 from behind at the detection position.

As shown in FIG. 1, the fitting portion 62 is inserted and mounted into a lower space 75 formed around the rear end tube portion 26 of the housing 20 at the detection position. As shown in FIGS. 7 and 8, the fitting portion 62 includes a pair of side portions 76 projecting downward from the respective base portions 64 and a bottom portion 77 bridged to extend in the lateral direction between lower end parts of the respective side portions 76. Each side portion 76 is plate-like and so arranged that plate surfaces face in the lateral direction. A vertical central side of each side portion 76 is slightly curved toward a lateral inner side. As shown in FIGS. 2, 6 and 7, an anti-slip portion 78 is formed on the outer surface of each side portion 76. The anti-slip portion 78 is shaped to extend laterally outward in a step-like manner toward the front on the outer surface of the side portion 76. When being moved from the initial position to the detection position, the detecting member 60 can be operated by placing fingers on the anti-slip portions 78 while gripping the respective side portions 76. Further, the bottom portion 77 is plate-like and has the same width in the front-rear direction as the respective side portions 76.

Further, the fitting portion 62 includes a surrounding portion 79 formed into an annular shape while having the same width in the front-rear direction as the respective side portions 76 and the bottom portion 77, and a plurality of protrusions 81 projecting forward from the front end surface of the surrounding portion 79. The rear end tube portion 26 of the housing 20 is fit into the surrounding portion 79. As shown in FIG. 2, the inner peripheral surface (surface facing radially inward) of the surrounding portion 79 is facing and contactable with the outer peripheral surface of the rear end tube portion 26. Four corner parts of the inner peripheral surface of the surrounding portion 79 are formed into a curved shape.

As shown in FIGS. 7 and 8, an upper plate part of the surrounding portion 79 is bridged along the lateral direction between upper end parts of the respective side portions 76. Entrance recesses 82 for allowing the entrance of the side end portions 28 of the housing 20 at the detection position are formed on both left and right sides of the upper plate part of the surrounding portion 79. The entrance recess 82 extends in the front-rear direction and is open in the front end of the upper plate portion.

A pair of left and right side plate parts of the surrounding portion 79 are coupled to upper end parts of the inner surfaces of the respective side portions 76 via side surface coupling portions 83. A lower plate part of the surrounding portion 79 is coupled to a lateral central part of the inner surface of the bottom portion 77 via a lower surface coupling portion 84. As shown in FIGS. 2 and 8, a rear end part of the fitting portion 62 is formed with a closing wall 85 for closing gaps between the respective side portions 76 and the surrounding portion 79 and between the bottom portion 77 and the surrounding portion 79.

As shown in FIG. 8, the respective protrusions 81 have a rectangular shape and are coupled to the front end surfaces of the lower plate part and the respective side plate parts of the surrounding portion 79 while being spaced apart in a circumferential direction of the surrounding portion 79. Each protrusion 81 is arranged to be fit into each through portion 31 of the coupling portion 23 at the detection position (see FIG. 1). As shown in FIG. 8, the respective protrusions 81 located on both left and right sides are coupled to the front end surfaces of the side surface coupling portions 83 in addition to the side plate parts of the surrounding portion 79. The protrusion 81 located on a lower side is in the form of a rib extending in the lateral direction and coupled to the front end surface of the lower surface coupling portion 84 in addition to the lower plate part of the surrounding portion 79. Further, a plate-like portion 86 formed between the respective entrance recesses 82 in the upper plate part of the surrounding portion 79 is arranged to be fit in the facing space 29 at the detection position as shown in FIG. 1.

As shown in FIG. 8, a plurality of projections 87 are formed on the inner surfaces of the respective protrusions 81 and the plate-like portion 86. A pair of the projections 87 are arranged at an interval in the lateral direction on the inner surface of the plate-like portion 86, and one projection 81 is arranged on the inner surface of each of the protrusion 81 located on the lower side and the protrusions 81 located on the both left and right sides. As shown in FIG. 2, with the rear end tube portion 26 fit inside the surrounding portion 79, the respective projections 87 are squeezed into contact with the outer peripheral surface of the rear end tube portion 26.

### (Functions of Connector 10)

The detecting member 60 is assembled with the housing 20 from behind and arranged at the initial position. At the initial position, the locking projection 73 of the arm portion 67 is fit in the lock hole 38 of the lock arm 36 and arranged to be lockable to the front surface of the lock hole 38 (see FIG. 3), and a forward (toward the detection position) movement of the detecting member 60 is restricted. Further, at the initial position, the front end parts of the respective projecting portions 65 resiliently ride over the locking portions 34 and the locking portions 34 are fit into the locking recesses 68 and arranged to be lockable to the locked surfaces 69 of the locking recesses 68 (see FIG. 4). In this way, the detecting member 60 is also restricted from moving (coming out) rearward.

With the detecting member 60 held at the initial position with respect to the housing 20, the respective base portions 64 are arranged behind and away from the respective side wall portions 32 (see FIG. 4) and the fitting portion 62 is arranged behind and away from the coupling portion 23 (see FIG. 3). The rear end tube portion 26 is lightly fit into the surrounding portion 79 of the fitting portion 62. In this state, the terminal fitting 40 crimped to the end part of the wire W together with the rubber plug 30 is inserted into the cavity 24 through the inside of the surrounding portion 79.

Thereafter, the housing 20 is fit and inserted into the receptacle 110 of the mating connector 100. If the housing 20 is inserted to a proper depth into the receptacle 110, the tab 131 of the mating terminal fitting 130 is inserted to a proper depth into the connecting portion 41 of the terminal fitting 40 and the terminal fitting 40 and the mating terminal fitting 130 are electrically connected. If the housing 20 and the mating connector 100 are properly connected, a mating lock portion 111 of the receptacle 110 is fit into the lock hole 38 of the lock arm 36 from below and arranged to be lockable to the front surface of the lock hole 38 and the housing 20 and the mating connector 100 are held in the connected state. The locking projection 73 is pushed up by the mating lock portion 111 and the arm portion 67 is resiliently deformed upward to be unlocked from the lock arm 36. In this way, the detecting member 60 becomes movable from the initial position to the detection position.

In the above state, fingers are placed on the anti-slip portions 78 of the respective side portions 76 and the detecting member 60 is pushed forward (toward the detection position). In a moving process of the detecting member 60, the inner peripheral surface of the surrounding portion 79 slides on the outer peripheral surface of the rear end tube portion 26 and the respective projecting portions 65 slide on the inner surfaces of the respective side wall portions 32, whereby a displacement movement of the detecting member 60 is guided. When the detecting member 60 reaches the detection position, the arm portion 67 resiliently returns and, as shown in FIG. 1, the locking projection 73 is facing and lockable to the front end surface of the lock arm 36 from front to restrict a rearward (toward the initial position) movement of the detecting member 60. Further, when the detecting member 60 reaches the detection position, the slope portions 74 of the respective base portions 64 are facing and contactable with the rear end surfaces of the respective side wall portions 32 and the front end surfaces of the respective side portions 76 and the bottom portion 77 constituting the fitting portion 62 are facing and contactable with the rear surface of the coupling portion 23. In this way, any further forward movement of the detecting member 60 at the detection position is restricted.

At the detection position, a tip part of the arm portion 67 is arranged to be visually confirmable through the recess 35 of the bridge portion 33 as shown in FIG. 1. Thus, the tip part of the arm portion 67 becomes visually confirmable through the recess 35, whereby it can be visually confirmed that the detecting member 60 has reached the detection position. Note that the visibility of the detecting member 60 can be enhanced by making the color of the outer surface of the detecting member 60 different from that of the outer surface of the housing 20.

Further, at the detection position, the entire rear end tube portion 26 is fit inside the fitting portion 62 and the outer peripheral surface of the rear end tube portion 26 is surrounded over an entire periphery by the surrounding portion 79 as shown in FIGS. 1 and 2. Each projection 87 is squeezed into contact with the outer peripheral surface of the rear end tube portion 26, each protrusion 81 is fit into each through portion 31 and the plate-like portion 86 is fit into the facing space 29. In this way, the detecting member 60 is positioned and held with rattling with respect to the housing 20 suppressed at the detection position.

On the other hand, if the housing 20 is not inserted to the proper depth into the receptacle 110, a state where the locking projection 73 is facing and lockable to the front surface of the lock hole 38 is maintained since the mating lock portion 111 of the receptacle 110 does not reach a position where the mating lock portion 111 is fit into the lock hole 38 of the lock arm 36. Thus, the detecting member 60 cannot be moved to the detection position even if being pushed. Therefore, it can be judged (detected) that the housing 20 has been properly connected to the mating connector 100 if the detecting member 60 becomes movable to the detection position.

As described above, the connector 10 of the first embodiment is provided with the housing 20 connectable to the mating connector 100 and the detecting member 60 to be mounted into the housing 20 movably in the front-rear direction and movable from the initial position to the detection position forward of the initial position when the mating connector 100 and the housing 20 are properly connected. The housing 20 includes the cavities 24 extending in the front-rear direction for accommodating the terminal fittings 40, and the rear end tube portion 26 surrounding rear parts of the cavities 24, the wires W connected to the terminal fittings 40 being pulled out from the rear end tube portion 26. The detecting member 60 includes the fitting portion 62 to be fit to the outer peripheral surface of the rear end tube portion 26 at the detection position. By fitting the fitting portion 62 to the outer peripheral surface of the rear end tube portion 26 at the detection position, a movement of the detecting member 60 with respect to the housing 20 can be hindered, wherefore the rattling of the detecting member 60 with respect to the housing 20 can be suppressed.

Further, the fitting portion 62 is lightly fit to the outer peripheral surface of the rear end tube portion 26 at the initial position and more deeply fit to the outer peripheral surface of the rear end tube portion 26 at the detection position. According to this, since the fitting portion 62 can be fit to the rear end tube portion 26 not only at the detection position, but also at the initial position, the rattling of the detecting member 60 with respect to the housing 20 can be suppressed also at the initial position (see FIG. 3).

Further, in the detecting member 60, the detection lock portion 61 to be locked to the housing 20 at each of the initial position and the detection position is arranged at the position in front of and above the fitting portion 62. Then, the detection lock portion 61 of the detecting member 60 can be hindered from being inclined upward or downward toward the front in the upper space 63 of the housing 20 by the fitting portion 62 arranged in the lower space 75, wherefore a state where the detection lock portion 61 is locked to the housing 20 can be more stably maintained.

Further, the step-like anti-slip portions 78 are formed on the outer peripheral surface of the fitting portion 62. Since a worker can move the detecting member 60 by placing fingers on the anti-slip portions 78 formed in wide ranges of the outer peripheral surface of the fitting portion 62, workability is excellent.

### Second Embodiment

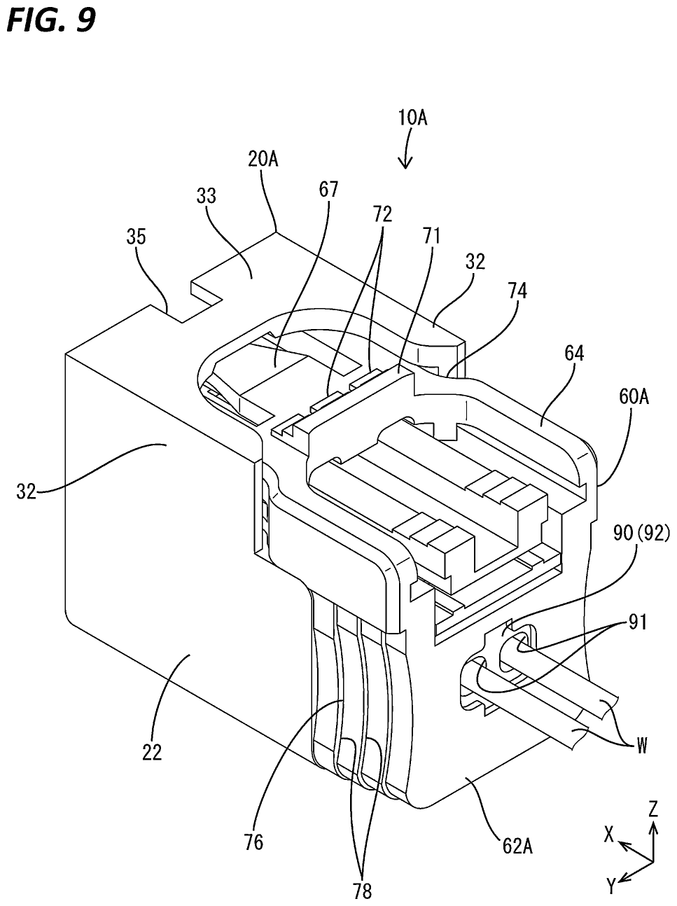

A connector 10A of a second embodiment shown in FIGS. 9 to 15 is provided with a sealing member 90 as a one-piece rubber plug without including the rubber plugs 30 individually corresponding to the respective terminal fittings 40 unlike the connector 10 of the above first embodiment. A fitting portion 62A of a detecting member 60A has a structure for holding the sealing member 90, and a rear end tube portion 26A of a housing 20A has a structure for accommodating the sealing member 90. The second embodiment differs from the first embodiment in including the aforementioned sealing member 90 and the structures for the sealing member 90. The other structure of the second embodiment is similar to that of the first embodiment. In the following description, parts, which are the same as or correspond to those of the first embodiment, are denoted by the same reference signs and repeated description is omitted. Note that, in FIG. 9, a front-rear direction is indicated by an arrow X, a lateral direction is indicated by an arrow Y and a vertical direction is indicated by an arrow Z.

### (Sealing Member 90)

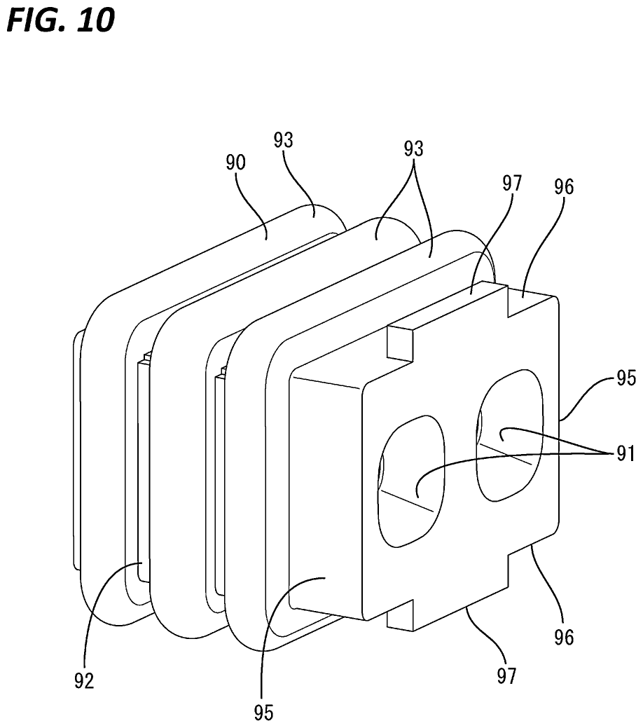

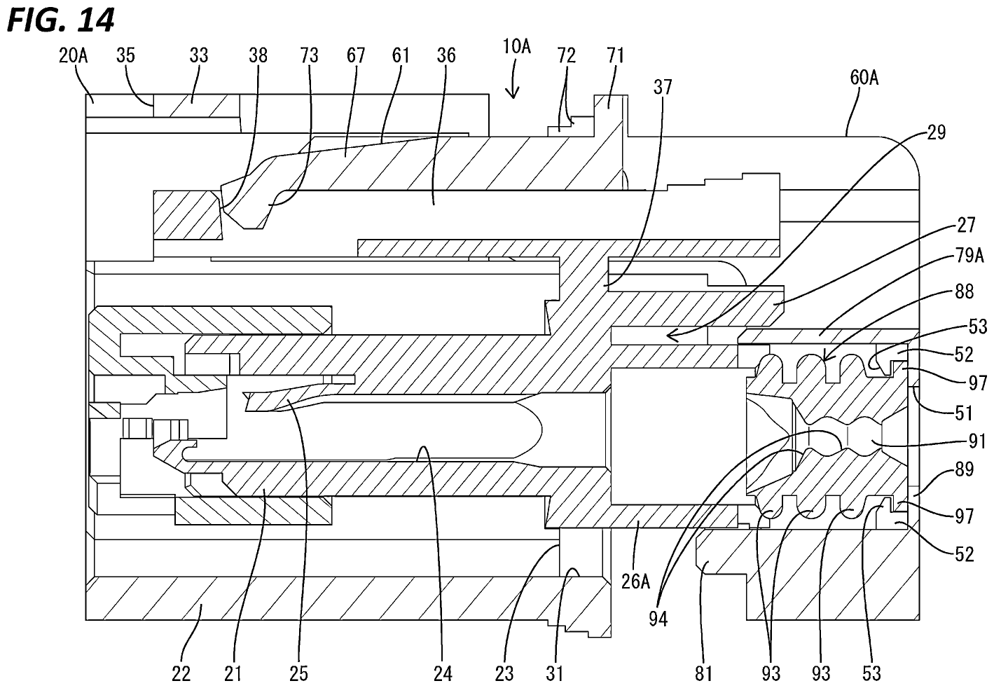

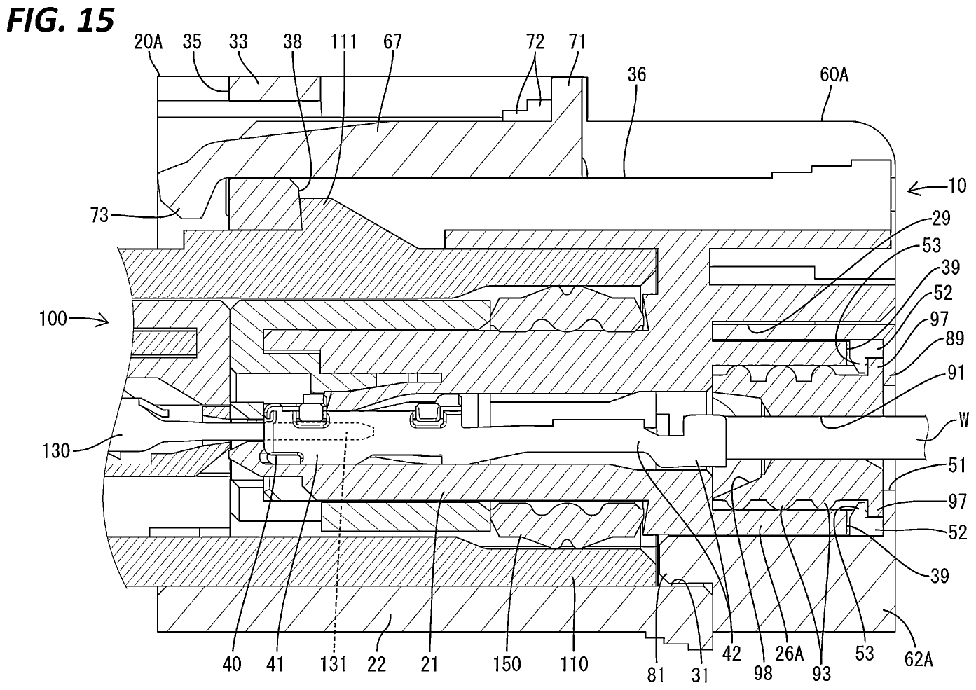

The sealing member 90 is made of rubber such as silicon rubber and, as shown in FIG. 10, configured as a one-piece rubber plug including a plurality of (two in the case of the second embodiment) sealing holes 91. The sealing member 90 includes a sealing body 92 in the form of a rectangular block and a plurality of outer peripheral lips 93 formed on the outer peripheral surface of the sealing body 92. The respective sealing holes 91 penetrate through the sealing body 92 in the front-rear direction and are arranged side by side in the lateral direction. As shown in FIG. 14, a plurality of inner peripheral lips 94 are formed on the inner peripheral surface of each sealing hole 91. The respective outer peripheral lips 93 are arranged side by side in the front-rear direction while circling around the outer peripheral surface of the sealing body 92. When the detecting member 60A is at a detection position, each outer peripheral lip 93 is held in close contact with the inner peripheral surface of the rear end tube portion 26A to be described later over an entire periphery (see FIG. 15). The respective inner peripheral lips 94 are arranged side by side in the front-rear direction while circling around the inner peripheral surface of each sealing hole 91. Each inner peripheral lip 94 is held in close contact with the outer peripheral surface of a wire W over an entire periphery. As shown in FIG. 10, the outer surfaces of a rear end part of the sealing body 92 include left and right surfaces 95 located on both left and right sides and extending along the vertical direction and upper and lower surfaces 96 located on both upper and lower sides and extending in the lateral direction. A pair of held portions 97 are formed in lateral central parts of the upper and lower surfaces 96 of the sealing body 92. The respective held portions 97 are in the form of ribs extending in the lateral direction on the upper and lower surface 96 and lockable to later-described holding portions 52 of the fitting portion 62A. The rear surface of each held portion 97 is continuous with the rear surface of the sealing body 92 without any step. As shown in FIG. 15, the front surface of the sealing body 92 is formed with an escape recess 98 for avoiding interference with barrel portions 42 of the terminal fittings 40. The front end of each sealing hole 91 is open in the inner surface of the escape recess 98.

### (Housing 20A)

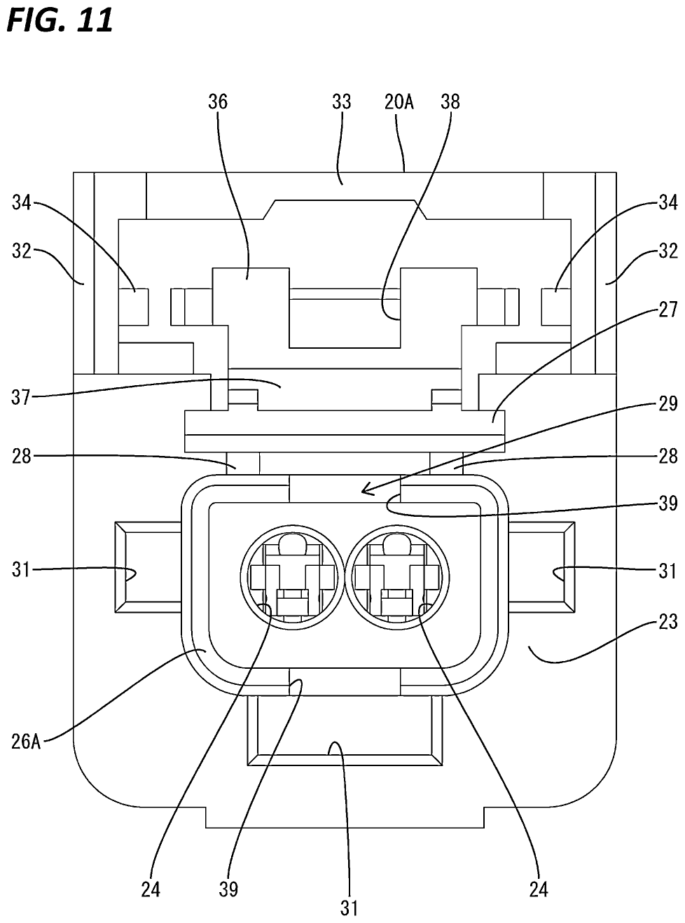

As shown in FIG. 11, the housing 20A includes the rear end tube portion 26A having an internal shape corresponding to the external shape of the sealing member 90. The rear end tube portion 26A has a rectangular tube shape longer in the lateral direction than in the vertical direction and having four round corners. The rear end tube portion 26A projects rearward from the rear surface of a coupling portion 23. The inner surface of each through portion 31 penetrating through the coupling portion 23 is continuous with the outer surface of the rear end tube portion 26A without any step. The upper wall of the rear end tube portion 26A is facing in parallel to a facing portion 27 below the facing portion 27.

Lateral central parts of the rear ends of the upper and lower walls of the rear end tube portion 26A are recessed to form a pair of cut portions 39. As shown in FIG. 15, when the detecting member 60A is at the detection position, tip parts of the respective holding portions 52 of the detecting member 60A for the sealing member 90 are arranged inside the respective cut portions 39 to avoid the interference of the housing 20A and the detecting member 60A.

### (Detecting Member 60A)

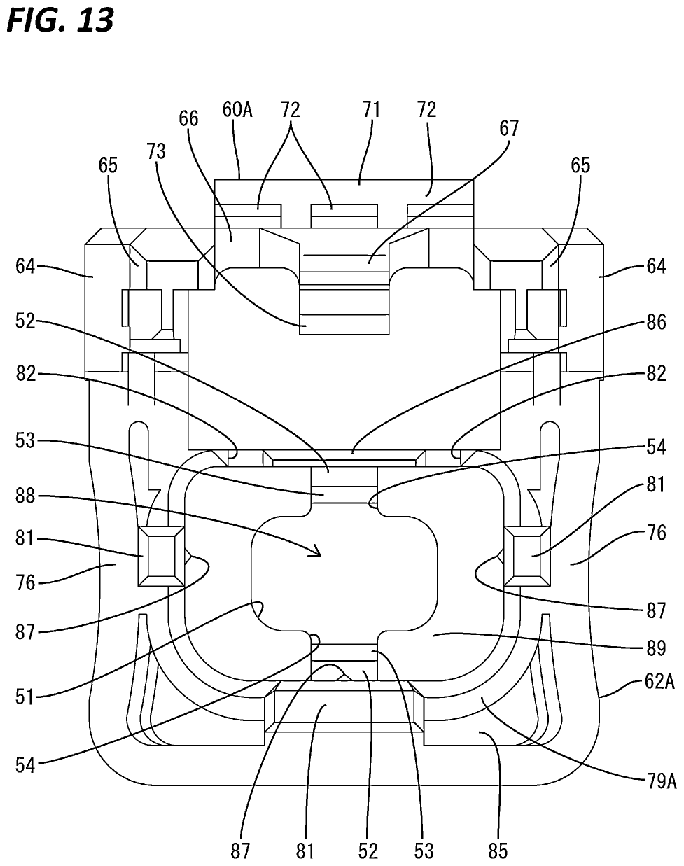

As shown in FIG. 13, the detecting member 60A includes a surrounding portion 79A having an internal shape corresponding to the external shape of the rear end tube portion 26A inside the fitting portion 62A. A holding space 88 capable of holding the sealing member 90 is formed to be open forward inside the surrounding portion 79A. The surrounding portion 79A is formed with a pressing portion 89 for restricting the sealing member 90 from coming out rearward from the holding space 88 (see FIGS. 14 and 15). The pressing portion 89 is in the form of a wall continuous with a closing wall 85. An opening 51 is formed to penetrate in the front-rear direction in a lateral central part of the pressing portion 89. The opening 51 has a rectangular shape with four round corners.

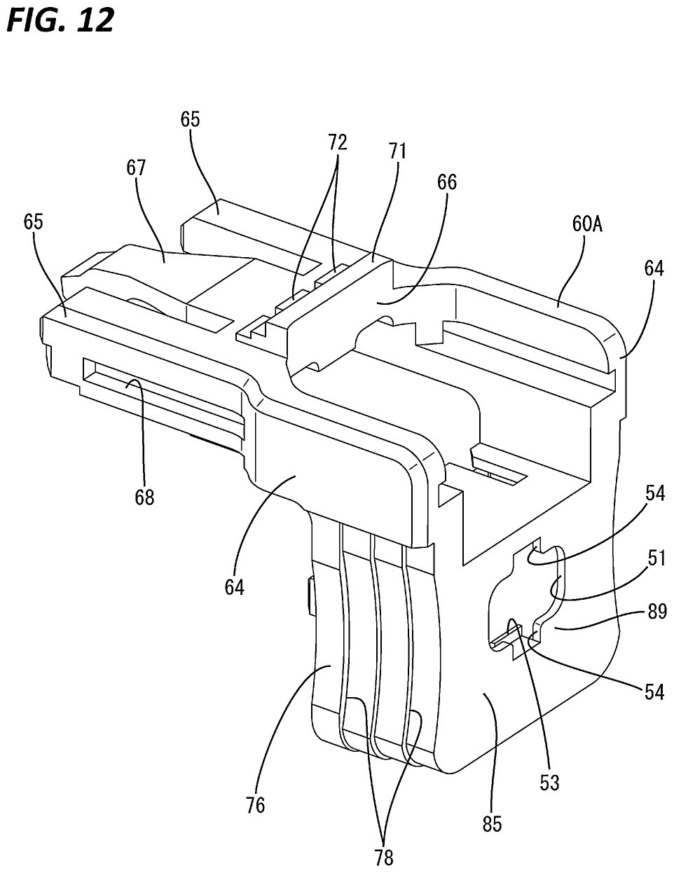

A pair of upper and lower holding portions 52 are arranged in the holding space 88 of the surrounding portion 79A. As shown in FIGS. 14 and 15, the respective holding portions 52 have base end parts on end parts on both upper and lower sides of the pressing portion 89 across the opening 51 and are formed to project forward from those base end parts. Each holding portion 52 is resiliently deformable in the vertical direction with the base end part as a fulcrum. A holding projection 53 is formed to project vertically inward (side facing the opposite holding portion 52) on a tip part (front end part) of each holding portion 52. As shown in FIG. 12, the rear surfaces of the holding projections 53 are open rearward of the surrounding portion 79A via mold removal spaces 54. The mold removal spaces 54 communicate with upper and lower end parts of the opening 51. As shown in FIGS. 14 and 15, the rear surfaces of the holding projections 53 are arranged to face and be lockable to the held portions 97, whereby the sealing member 90 is restricted from coming out rearward from the holding space 88.

### (Functions of Connector 10A)

Prior to the assembly of the detecting member 60A with the housing 20A, the sealing member 90 is mounted into the holding space 88 of the surrounding portion 79A from behind. The front surfaces of the respective held portions 97 are facing and contactable with the holding projections 53 and the rear surfaces of the respective held portions 97 are facing and contactable with pressing portions 89, whereby the sealing member 90 is held in the fitting portion 62A and restricted from coming out forward and rearward (see FIG. 14).

Subsequently, the detecting member 60A is held at an initial position with respect to the housing 20A. As shown in FIG. 14, at the initial position, the rear end tube portion 26A is lightly fit inside the surrounding portion 79A and each sealing hole 91 of the sealing member 90 is arranged behind the rear end opening of each cavity 24. The cavity 24 and the sealing hole 91 are arranged side by side on the same axis in the front-rear direction, which is an insertion direction of the terminal fitting 40. Further, at the initial position, the rear surface of the sealing member 90 is facing the inside of the opening 51 of the detecting member 60A and the rear end opening of each sealing hole 91 is arranged to communicate with the inside of the opening 51.

Subsequently, the terminal fitting 40 connected to an end part of the wire W is inserted into the sealing hole 91 through the opening 51. The terminal fitting 40 moves straight forward while being guided by the sealing hole 91, and is inserted into the cavity 24 and accommodated in the housing 20A from the sealing hole 91. After each terminal fitting 40 is accommodated into the housing 20A, the housing 20A is connected to a mating connector 100 and held in that state. With the housing 20A properly connected to the mating connector 100, the detecting member 60A is moved to the detection position. At the detection position, as shown in FIG. 15, the rear end tube portion 26A is deeply fit inside the surrounding portion 79A and the sealing member 90 is deeply fit inside the rear end tube portion 26A. Then, the front surface of the sealing member 90 contacts the rear surface of the coupling portion 23, and each sealing hole 91 communicates with each cavity 24 from behind. Here, the sealing member 90 is compressed in the front-rear direction between the coupling portion 23 and the pressing portion 89 and the respective inner peripheral lips 94 are tightly held in close contact with the outer peripheral surfaces of the wires W. Further, the respective outer peripheral lips 93 of the sealing member 90 are held in close contact with the inner peripheral surface of the rear end tube portion 26A. In this way, the sealing member 90 liquid-tightly seals between the rear end tube portion 26A and the wires W.

As described above, the connector 10A of the second embodiment is provided with the sealing member 90 including the sealing holes 91, through which the wires W are liquid-tightly insertable. The fitting portion 62A includes the holding portions 52 for holding the sealing member 90 inside and the opening 51 for opening the sealing holes 91 of the sealing member 90 rearward. When the detecting member 60A reaches the detection position with respect to the housing 20A, the opening 51 communicates with the cavities 24 from behind and the outer peripheral surface of the sealing member 90 is held in close contact with the inner peripheral surface of the rear end tube portion 26A.

If the position of the terminal fitting 40 passing through the inside of the opening 51 is not determined at the initial position, the terminal fitting 40 may be shifted from a position where the terminal fitting 40 is insertable into the cavity 24. In that respect, according to the second embodiment, when the detecting member 60A is at the initial position, the sealing member 90 is held inside the fitting portion 62A and the terminal fitting 40 can be passed through the sealing hole 91 of this sealing member 90. Thus, the position of the terminal fitting 40 passing through the inside of the opening 51 is determined to be the position where the terminal fitting 40 is insertable into the cavity 24 (position on the same axis in the insertion direction of the terminal fitting 40). As a result, an operation of inserting the terminal fitting 40 into the cavity 24 can be smoothly performed.

Further, in the case of the second embodiment, the plurality of cavities 24 are formed in the housing 20A, and the respective cavities 24 collectively communicate with one opening 51. The sealing member 90 is configured as a one-piece rubber plug including the plurality of sealing holes 91 capable of communicating with the respective cavities 24. If the plurality of cavities 24 collectively communicate with one opening 51, an opening diameter of the opening 51 increases and it becomes difficult to determine the position of the terminal fitting 40 passing through the inside of the opening 51. In that respect, if the sealing member 90 is a one-piece rubber plug as described above, the position of the terminal fitting 40 can be determined without any trouble by each sealing hole 91.

### OTHER EMBODIMENTS OF PRESENT DISCLOSURE

The first embodiment and the second embodiment (first and second embodiments) disclosed this time should be considered illustrative in all aspects, rather than restrictive.

In the case of the above first and second embodiments, the fitting portion 62, 62A covers the outer peripheral surface of the rear end tube portion 26, 26A over the entire periphery at the detection position. In contrast, according to another embodiment, a fitting portion may not cover a part of the outer peripheral surface of a rear end tube portion in a circumferential direction at the detection position.

In the case of the above first and second embodiments, the fitting portion 62, 62A is fit to the outer peripheral surface of the rear end tube portion 26, 26A in an entire range from the initial position to the detection position. In contrast, according to another embodiment, a fitting portion only has to be fit to the outer peripheral surface of a rear end tube portion at least at the detection position and, for example, may not be fit to the outer peripheral surface of the rear end tube portion at the initial position.

In the case of the second embodiment, the rear surface of the sealing member 90 is facing the inside of the opening 51. In contrast, according to another embodiment, the rear surface of a sealing member may be arranged at a position projecting rearward from the inside of an opening.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing connectable to a mating connector; and
a detecting member to be mounted into the housing movably in a front-rear direction, the detecting member being movable from an initial position to a detection position forward of the initial position when the mating connector and the housing are properly connected,
the housing including a cavity extending in the front-rear direction for accommodating a terminal fitting and a rear end tube portion surrounding a rear part of the cavity, a wire connected to the terminal fitting being pulled out from the rear end tube portion, and
the detecting member including a fitting portion to be fit to an outer peripheral surface of the rear end tube portion at least at the detection position.

2. The connector of claim 1, wherein the fitting portion is lightly fit to the outer peripheral surface of the rear end tube portion at the initial position and more deeply fit to the outer peripheral surface of the rear end tube portion at the detection position.

3. The connector of claim 1, wherein a detection lock portion to be locked to the housing at each of the initial position and the detection position is arranged at a position in front of and above the fitting portion in the detecting member.

4. The connector of claim 1, wherein a step-like anti-slip portion is formed on an outer peripheral surface of the fitting portion.

5. The connector of claim 1, further comprising a sealing member including a sealing hole, the wire being liquid-tightly insertable through the sealing hole, wherein:
the fitting portion includes a holding portion for holding the sealing member and an opening for opening the sealing hole of the sealing member rearward, and
the opening communicates with the cavity and an outer peripheral surface of the sealing member is held in close contact with an inner peripheral surface of the rear end tube portion when the detecting member reaches the detection position with respect to the housing.

6. The connector of claim 5, wherein:
the housing is formed with a plurality of the cavities,
the plurality of cavities collectively communicate with the opening, and
the sealing member is a one-piece rubber plug including a plurality of the sealing holes capable of communicating with the plurality of cavities.
